(19) United States
(12) Patent Application Publication
(10) Pub. No.: US 2026/0032688 A1
(43) Pub. Date: Jan. 29, 2026

(54) TECHNIQUES FOR SELECTING COMMON RESOURCES FOR CHANNEL MONITORING

(71) Applicant: Lenovo (Singapore) Pte. Ltd., Singapore (SG)

(72) Inventors: Karthikeyan Ganesan, Kronberg im Taunus (DE); Ravi Kuchibhotla, Chicago, IL (US)

(21) Appl. No.: 18/786,364

(22) Filed: Jul. 26, 2024

(51) Int. Cl. H04W 72/23; H04W 68/02; H04W 74/0833

(52) U.S. Cl. CPC H04W 72/23; H04W 68/02; H04W 74/0833

(57) ABSTRACT

Various aspects of the present disclosure relate to methods and apparatuses for determining, identifying, or selecting one or more common resources for channel monitoring. For example, a network entity (NE) may determine one or more supported bandwidths for a plurality of user equipments (UEs). The plurality of UEs may correspond to at least two different types (e.g., types of UEs). The NE may configure one or more common resources for channel monitoring based at least in part on one or more of an initial bandwidth for initial access to the NE or the one or more supported bandwidths. The NE may transmit a configuration message indicating the one or more common resources, which may be associated with one or more of a set of paging occasions (POs) or a set of random access channel (RACH) occasions (ROs).

### TECHNICAL FIELD

The present disclosure relates to wireless communications, and more specifically to techniques for selecting a common resource for channel monitoring based on (e.g., according to) a unified common channel framework.

### BACKGROUND

A wireless communications system may include one or multiple network communication devices, such as base stations, which may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like)). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” Further, as used herein, including in the claims, a “set” may include one or more elements.

Various aspects of the present disclosure relate to methods and apparatuses for determining, identifying, or selecting one or more common resources for channel monitoring. For example, a network entity, such as a base station may determine one or more supported bandwidths for a plurality of UEs. The plurality of UEs may correspond to at least two different device types (e.g., types of UEs). The base station may configure one or more common resources (also referred to as common channel monitoring resources) for channel monitoring based at least in part on one or more of an initial bandwidth for initial access to the base station or the supported bandwidths. The base station may transmit a UE-specific configuration message indicating the one or more common resources. The one or more common resources may be associated with one or more of a set of paging occasions (POs) or a set of random access channel (RACH) occasions (ROs).

### BRIEF DESCRIPTION OF THE DRAWINGS

FIG. 1 illustrates an example of a wireless communications system in accordance with aspects of the present disclosure.

FIG. 2 illustrates an example of a protocol stack in accordance with aspects of the present disclosure.

FIG. 3 illustrates an example of a transmission diagram in accordance with aspects of the present disclosure.

FIG. 4 illustrates an example of a transmission diagram for an initial bandwidth part (BWP) in accordance with aspects of the present disclosure.

FIG. 5 illustrates an example of a configuration of an initial BWP for different device types in accordance with aspects of the present disclosure.

FIG. 6A illustrates an example of allocating POs within a bandwidth of an initial common BWP in accordance with aspects of the present disclosure.

FIG. 6B illustrates another example of allocating POs within a bandwidth of an initial common BWP in accordance with aspects of the present disclosure.

FIG. 6C illustrates yet another example of allocating POs within a bandwidth of an initial common BWP in accordance with aspects of the present disclosure.

FIG. 7 illustrates an example of multi-stage downlink control information (DCI) for paging with frequency division multiplexed (FDMed) POs in accordance with aspects of the present disclosure.

FIG. 8 illustrates an example of a UE in accordance with aspects of the present disclosure.

FIG. 9 illustrates an example of a processor in accordance with aspects of the present disclosure.

FIG. 10 illustrates an example of a network equipment (NE) in accordance with aspects of the present disclosure.

FIG. 11 illustrates a flowchart of a method performed by a NE in accordance with aspects of the present disclosure.

### DETAILED DESCRIPTION

In a wireless communications system, a node (e.g., a base station, a network entity, a UE as described herein) may support energy saving. For example, the node may be configured to be capable of operating in one or more modes, where each mode is associated with a respective power consumption by the node. Examples modes may include, but not limited to, an inactive mode, an idle mode, and an active mode. In one or more of the inactive mode or the idle mode, the node may refrain from performing communication (e.g., transmission and/or reception of signaling), which may yield in power savings as one or more components (e.g., circuitry, antennas, radios, encoders, decoders) of the node can be powered down and/or enter (e.g., switch to) a lower power mode (e.g., a reduced power consumption mode). In the active mode, the node may perform communication (e.g., transmission and/or reception of signaling), which may result in higher power consumption compared to the inactive mode and/or the idle mode, due to the components (e.g., circuitry, antennas, radios, encoders, decoders) performing one or more actions (e.g., tasks, operations) to support the communication.

In some cases, a node (e.g., a base station) in an inactive mode and/or an idle mode may periodically enter an active mode to transmit paging messages to one or more other nodes (e.g., UEs). A paging message can inform (e.g., notify, indicate to) the UE of a transmission (e.g., an incoming transmission, a scheduled transmission, a pending transmission). For example, a set of resources for use by the node to transmit the paging messages (also referred to as paging occasions (POs) and/or paging frames (PFs)) may be distributed (e.g., allocated, scheduled) uniformly across a time domain. Due to the uniform distribution of the set of resources across the time domain, the node may frequently enter the active mode to transmit the paging messages, which may lead to increased power consumption by the node.

In some wireless communication systems, such as long-term evolution (LTE) and 5G new radio (NR) networks, nodes (e.g., base stations, network entities, UEs as described herein) may use a common channel for broadcasting information. A common channel may refer to a type of radio channel, which may be shared among all nodes (e.g., UEs) within a cell (e.g., coverage area of a base station). Examples of common channels in 5G NR include the primary synchronization signal (PSS) and secondary synchronization signal (SSS), the physical broadcast channel (PBCH), the control resource set (CORESET), the physical downlink control channel (PDCCH), the broadcast control channel (BCCH), the paging control channel (PCCH), and the RACH. In some cases, the common channel may be used by the nodes for broadcasting essential information required for initial access, synchronization signals, DCI, paging messages, RACH message, and the like. The common channel might not carry data (e.g., downlink data, uplink data, both which may be referred to as user data) but may instead carry necessary information to the nodes within the cell.

Various aspects of the present disclosure relate to improved techniques for managing transmission of essential information over a common channel to one or more nodes. Specifically, a node (e.g., a base station) may be capable of selecting a common control channel (e.g., a common physical downlink control channel (PDCCH), a common broadcast channel, a common PCCH, and/or a common RACH) for transmission of the essential information over the common control channel to one or more other nodes (e.g., bandwidth limited UE (BL-UE), a wideband UE (WB-UE)) within a cell associated with the node (e.g., the base station). In some examples, the node may support multiplexing (e.g., FDM) resources (e.g., POs and/or ROs) associated with the common control channel for transmission (e.g., a paging transmission) of the essential information, where the multiplexing results in shorter transmit time for the node. By enabling the node to select the common control channel, multipex resources associated with the common control channel for transmission (e.g., a paging transmission) of the essential information, or both, according to one or more aspects as described herein, the node may experience reduced power consumption.

Aspects of the present disclosure are described in the context of a wireless communications system.

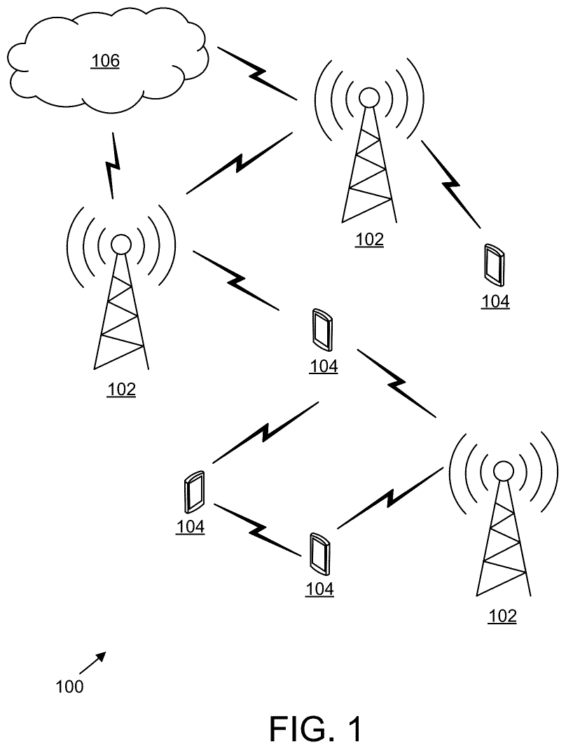

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as a Long-Term Evolution (LTE) network or an LTE-Advanced (LTE-A) network. In some other implementations, the wireless communications system 100 may be a New Radio (NR) network, such as a 5G network, a 5G-Advanced (5G-A) network, or a 5G ultrawideband (5G-UWB) network.

In other implementations, the wireless communications system 100 may be a combination of a 4G network and a 5G network, or other suitable radio access technology (RAT) including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an internet-of-things (IOT) device, an internet-of-everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N3, or network interface). In some implementations, the NE 102 may communicate with each other directly. In some other implementations, the NE 102 may communicate with each other indirectly (e.g., via the CN 106). In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management function (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signaling bearers, etc.) for the one or more UEs 104 served by the one or more NE 102 associated with the CN 106.

The CN 106 may communicate with a packet data network over one or more backhaul links (e.g., via an S1, N2, N3, or another network interface). The packet data network may include an application server. In some implementations, one or more UEs 104 may communicate with the application server. A UE 104 may establish a session (e.g., a protocol data unit (PDU) session, or a PDN connection, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally, or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively.

Each slot may include a number (e.g., quantity) of symbols (e.g., orthogonal frequency domain multiplexing (OFDM) symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHZ-24.25 GHZ), FR4 (52.6 GHz-114.25 GHz), FR4a or FR4-1 (52.6 GHZ-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

According to implementations, one or more of the NEs 102 and the UEs 104 are operable to implement various aspects of the techniques described with reference to the present disclosure.

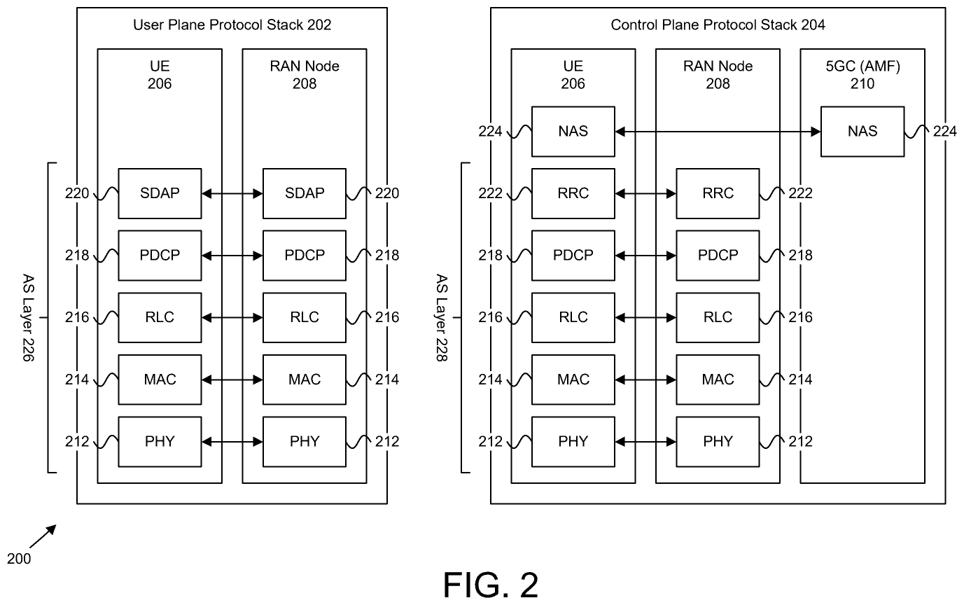

FIG. 2 illustrates an example of a protocol stack 200, in accordance with aspects of the present disclosure. While FIG. 2 shows a UE 206, a RAN node 208, and a 5G core network (5GC) 210 (e.g., comprising at least an AMF), these are representative of a set of UEs 104 interacting with an NE 102 (e.g., base station) and a CN 106. As depicted, the protocol stack 200 comprises a user plane protocol stack 202 and a control plane protocol stack 204. The user plane protocol stack 202 includes a physical (PHY) layer 212, a medium access control (MAC) sublayer 214, a radio link control (RLC) sublayer 216, a packet data convergence protocol (PDCP) sublayer 218, and a service data adaptation protocol (SDAP) sublayer 220. The control plane protocol stack 204 includes a PHY layer 212, a MAC sublayer 214, a RLC sublayer 216, and a PDCP sublayer 218. The control plane protocol stack 204 also includes a radio resource control (RRC) layer 222 and a NAS layer 224.

The AS layer 226 (also referred to as “AS protocol stack”) for the user plane protocol stack 202 consists of at least SDAP, PDCP, RLC and MAC sublayers, and the physical layer. The AS layer 228 for the control plane protocol stack 204 consists of at least RRC, PDCP, RLC and MAC sublayers, and the physical layer. The layer-1 (L1) includes the PHY layer 212. The layer-2 (L2) is split into the SDAP sublayer 220, PDCP sublayer 218, RLC sublayer 216, and MAC sublayer 214. The layer-3 (L3) includes the RRC layer 222 and the NAS layer 224 for the control plane and includes, e.g., an internet protocol (IP) layer and/or PDU Layer (not depicted) for the user plane. L1 and L2 are referred to as “lower layers,” while L3 and above (e.g., transport layer, application layer) are referred to as “higher layers” or “upper layers.”

The PHY layer 212 offers transport channels to the MAC sublayer 214. The PHY layer 212 may perform a beam failure detection procedure using energy detection thresholds, as described herein. In certain embodiments, the PHY layer 212 may send an indication of beam failure to a MAC entity at the MAC sublayer 214. The MAC sublayer 214 offers logical channels to the RLC sublayer 216. The RLC sublayer 216 offers RLC channels to the PDCP sublayer 218. The PDCP sublayer 218 offers radio bearers to the SDAP sublayer 220 and/or RRC layer 222. The SDAP sublayer 220 offers QoS flows to the core network (e.g., 5GC). The RRC layer 222 manages the addition, modification, and release of carrier aggregation and/or dual connectivity. The RRC layer 222 also manages the establishment, configuration, maintenance, and release of signaling radio bearers (SRBs) and data radio bearers (DRBs).

The NAS layer 224 is between the UE 206 and an AMF in the 5GC 210. NAS messages are passed transparently through the RAN. The NAS layer 224 is used to manage the establishment of communication sessions and for maintaining continuous communications with the UE 206 as it moves between different cells of the RAN. In contrast, the AS layers 226 and 228 are between the UE 206 and the RAN (i.e., RAN node 208) and carry information over the wireless portion of the network. While not depicted in FIG. 2, the IP layer exists above the NAS layer 224, a transport layer exists above the IP layer, and an application layer exists above the transport layer.

The MAC sublayer 214 is the lowest sublayer in the L2 architecture of the NR protocol stack. Its connection to the PHY layer 212 below is through transport channels, and the connection to the RLC sublayer 216 above is through logical channels. The MAC sublayer 214 therefore performs multiplexing and demultiplexing between logical channels and transport channels: the MAC sublayer 214 in the transmitting side constructs MAC PDUs (also known as transport blocks (TBs)) from MAC service data units (SDUs) received through logical channels, and the MAC sublayer 214 in the receiving side recovers MAC SDUs from MAC PDUs received through transport channels.

In the radio protocol architectures described herein, the term “SDU” refers to a data unit that is received by a sublayer from a higher sublayer, or that is sent by a sublayer to a higher sublayer. Likewise, the term “PDU” refers to a data unit that is sent by a sublayer to a lower sublayer, or that is received by a sublayer from a lower sublayer.

The MAC sublayer 214 provides a data transfer service for the RLC sublayer 216 through logical channels, which are either control logical channels which carry control data (e.g., RRC signaling) or traffic logical channels which carry user plane data. On the other hand, the data from the MAC sublayer 214 is exchanged with the PHY layer 212 through transport channels, which are classified as uplink (UL) or downlink (DL). Data is multiplexed into transport channels depending on how it is transmitted over the air.

The PHY layer 212 is responsible for the actual transmission of data and control information via the air interface, i.e., the PHY layer 212 carries all information from the MAC transport channels over the air interface on the transmission side. Some of the important functions performed by the PHY layer 212 include coding and modulation, link adaptation (e.g., adaptive modulation and coding (AMC)), power control, cell search and random access (for initial synchronization and handover purposes) and other measurements (inside the Third Generation Partnership Project (3GPP) system (i.e., NR and/or LTE system) and between systems) for the RRC layer 222. The PHY layer 212 performs transmissions based on transmission parameters, such as the modulation scheme, the coding rate (i.e., the modulation and coding scheme (MCS)), the number of physical resource blocks (PRBs), etc.

In some embodiments, the protocol stack 200 may be an NR protocol stack used in a 5G NR system. Note that an LTE protocol stack may comprise similar structure to the protocol stack 200, with the differences that the LTE protocol stack lacks the SDAP sublayer 220 in the AS layer 226, that an EPC replaces the 5GC 210, and that the NAS layer 224 is between the UE 206 and an MME in the EPC. Also note that the present disclosure distinguishes between a protocol layer (such as the aforementioned PHY layer 212, MAC sublayer 214, RLC sublayer 216, PDCP sublayer 218, SDAP sublayer 220, RRC layer 222 and NAS layer 224) and a transmission layer in multiple-input multiple-output (MIMO) communication (also referred to as a “MIMO layer” or a “data stream”).

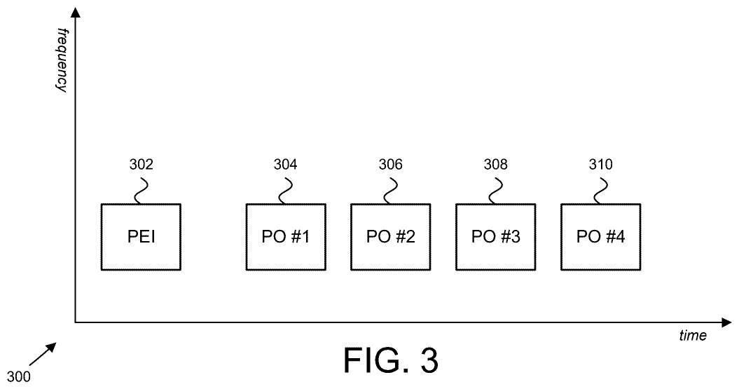

FIG. 3 depicts an example of a transmission diagram 300 in accordance with aspects of the present disclosure. In some examples, the transmission diagram 300 implements or is implemented by aspects of the wireless communications system 100. For example, the transmission diagram 300 can be implemented by a UE and a NE, which may be examples of a UE 104 and a NE 102 as described with reference to FIG. 1. The NE and/or the UE can operate in one or more modes, including an active mode and an inactive mode, to reduce power consumptions of the NE and/or the UE.

In some examples, a NE and a UE can transmit and receive signaling, such as control signaling and/or data. The NE and the UE can transmit and receive the signaling via one or more communication links. For example, the NE can transmit signaling to the UE via a downlink communication link, while the UE can transmit signaling to the NE via an uplink communication link. The signaling can occupy one or more time-frequency resources, which can also be referred to as communication resources or resources. For example, the NE and/or the UE can transmit signaling using one or more radio frames. A radio frame can be further divided into smaller units of time, such as slots or occasions. The NE and/or the UE can transmit the signaling using one or more frequency resources, including, but not limited to, frequency bands, component carriers (CCs), bandwidth parts (BWPs), among other example frequency resources.

In some examples, a NE and/or a UE can operate according to one or more modes or operation states. For example, a UE may implement discontinuous reception (DRX) techniques to reduce a power consumption at the UE. DRX is a technique used to conserve power by allowing a receiver of the UE to enter a sleep mode or other low-power state during time periods when the UE is not expecting incoming data (e.g., inactive periods). By avoiding reception during inactive periods, DRX reduces power consumption at the UE, extending battery life and conserving energy.

In some examples, reducing power consumption at the UE and/or the NE can reduce emissions by the UE and/or the NE, as well as reduce an operating expense related to implementing UEs and NEs with a continued rise in mobile data traffic (e.g., 6.4 gigabytes (GB) per user per month, which is forecast to grow threefold on a per-user basis over the next five years). In some cases, 5G NR improved energy-efficiency per GB over previous generations of mobility. However, new 5G use cases and the adoption of millimeter Wave (mm-Wave) communications may cause an increase in NEs to serve UEs over a geographic coverage area, leading to higher emissions.

Network energy saving can lead to environmental sustainability by reducing environmental impact (e.g., greenhouse gas emissions) and can reduce operational cost. As 5G is becoming pervasive across industries and geographical areas, handling more advanced services and applications that use relatively high data rates (e.g., greater than a threshold data rate, including extended reality (XR) related data), networks are becoming denser, use more antennas, have an increase in bandwidths, and more frequency bands.

In some examples, the energy cost on a mobile network accounts for a relatively large amount of (e.g., 23%) of a total operator cost. The NEs and other devices in a RAN account for a relatively large amount (e.g., most) of the energy consumption, such as from an active antenna unit (AAU), with data centers and fiber transport accounting for a relatively small share. The power consumption of a RAN can be split into two components, including a dynamic power consumption component, where power is consumed when data transmission and/or reception is ongoing, and a static power consumption component, where power is constantly consumed to maintain the operation of the devices in the RAN, e.g., even when the data transmission and/or reception is not on-going.

A NE expends substantial energy (e.g., greater than a threshold power consumption) to transmit signaling, including, but not limited to, synchronization signal blocks (SSBs), physical broadcast channels (PBCHs) that include a master information block (MIB), one or more system information blocks (SIBs), and/or other system information and paging messages. The NE can transmit SSBs and SIBs (e.g., a SIB type 1 (SIB1)) for cell identification, idle mode mobility, connected mode mobility, etc.

For example, the NE can periodically broadcast one or more SSBs to UEs within a coverage area of the NE. The SSBs include information for the UEs to perform time and frequency synchronization with the NE for reception of system information (e.g., the SIB1). A PBCH can include a MIB that indicates a system frame number (SFN), a subcarrier spacing, a bandwidth, among other information for reception of a SIB1. The SIB1 can indicate one or more time-frequency resources that include paging messages. The paging messages notify a UE in an inactive mode or idle mode of an incoming transmission (e.g., a data transmission). However, one or more of the UEs that the NE transmits the paging messages to may not be present within a coverage area of the NE. Thus, the energy consumption from the paging messages and related signaling can be unnecessary.

Additionally, or alternatively, conventional techniques for allocating time-frequency resources for transmission and reception of paging messages can include distributing allocated time resources evenly across a time domain for a given frequency resource in a frequency domain. The resources can include POs that define a time interval and/or frequency within a radio frame, referred to as a paging frame (PF), during which a UE is to monitor for a paging message and/or during which a NE is to transmit a paging message. POs are scheduled by one or more parameters provided in the SIB1. Evenly distributing POs across a time domain hinders a RAN node (e.g., a NE) from entering deeper sleep modes (e.g., inactive or idle modes) for extended durations and/or from deactivating one or more components, as the NE may wake up periodically to send paging messages. The NE may wake up to transmit the paging messages even if the paged UEs are not in the coverage area of the NE, as the location of UEs in an inactive mode or idle mode is known at a registration area level (e.g., one or more tracking areas received in registration accept rather than by the NE).

In some examples, a UE may use DRX in an idle mode or an inactive mode (e.g., a RRC idle state (RRC_IDLE) and/or an RRC inactive state (RRC_INACTIVE)) to reduce power consumption. In an RRC_IDLE state, the UE is not actively communicating with the NE. The UE periodically monitors for paging messages and can transition to an active state (e.g., RRC_CONNECTED) upon receiving a paging message. The UE conserves battery power in an RRC_IDLE state as no signaling connection is maintained with the NE.

In an RRC_INACTIVE state the UE maintains a connection (e.g., an RRC connection) with the NE, which provides for a faster transition to an active state compared to the RRC_IDLE state. For example, the UE can receive a paging message and resume communications with a NE without reestablishing an RRC connection with the NE. In an RRC_CONNECTED state, the UE is actively communicating with the NE.

In the RRC_INACTIVE and the RRC_IDLE states a NE can transmit control signaling to a UE that schedules one or more monitoring occasions, referred to as POs, during which the UE is to monitor for paging messages. The POs can fall within an active period of a DRX cycle of the UE.

For example, the UE monitors one PO per DRX cycle, where the PO includes a set of physical downlink control channel (PDCCH) monitoring occasions and can include multiple time slots (e.g., subframes or OFDM symbols) in which a paging DCI message can be sent. A PF is a radio frame that may contain one or more POs or is a starting point of a PO. In multi-beam operations, the same paging message and the same short message can be repeated in respective transmitted beams, and the UE can select a beam for reception of a paging message and a short message. A paging message can be the same for both RAN-initiated paging and CN-initiated paging.

The UE initiates an RRC connection resume procedure upon receiving RAN initiated paging. If the UE receives a CN initiated paging in an RRC_INACTIVE state, then the UE switches from the RRC_INACTIVE state to an RRC_IDLE and informs a NAS layer of the switch. In some cases, the NE (e.g., a RAN and/or a CN) and/or the UE can determine a PF and PO for paging according to Equation 1:

$$( SFN + {PF}_{offset} ) mod ( T ) = T ( divN ) * ( {UE}_{ID} mod ( N ) ) , \qquad ( 1 )$$

where the NE determines an index is of the PO according to Equation 2:

$${i}_{s} = floor ( \frac{{UE}_{ID}}{N} ) mod ( {N}_{s} ) . \qquad ( 2 )$$

The NE and/or the UE can determine a PDCCH monitoring occasion for paging according to one or more parameters, such as a pagingSearchSpace parameter, a firstPDCCH-MonitoringOccasionOfPO parameter, and a nrofPDCCH-MonitoringOccasionPerSSB-InPO parameter, which can be preconfigured or defined (e.g., as described in 3GPP technical specification (TS) 38.331).

If a SearchSpaceId parameter has a value of zero for pagingSearchSpace, then one or more PDCCH monitoring occasions for paging are the same as for remaining minimum system information (RMSI).

If the SearchSpaceId parameter has a value of zero for pagingSearchSpace, then Nₛ can have a defined integer value (e.g., one or two). If Nₛ is one, then there is one PO that starts from a first PDCCH monitoring occasion for paging in a PF. If Nₛ is two, then there is a PO in either a first half frame (e.g., iₛ=0) or a second half frame (e.g., iₛ=1) of the PF.

In some cases, if the SearchSpaceId parameter has a value other than zero for pagingSearchSpace, then the UE can monitor for a paging message in a PO with a defined index (e.g., iₛ+1).

A PO is a set of consecutive PDCCH monitoring occasions (e.g., S*X PDCCH monitoring occasions, where S is a number of actual transmitted SSBs determined according to a parameter ssb-PositionsInBurst in SIB1 and X is equal to a value of a parameter nrofPDCCH-MonitoringOccasionPerSSB-InPO if configured or is equal to 1 otherwise). In some examples, a (x*S+K)^{th} PDCCH monitoring occasion for paging in the PO corresponds to the K^{th} transmitted synchronization signal block (SSB), where x=0, 1, . . . , K−1, K=1, 2, . . . , S.

The PDCCH monitoring occasions for paging that do not overlap with uplink symbols (e.g., determined according to a defined configuration, tdd-UL-DL-ConfigurationCommon) are sequentially numbered from zero starting from the first PDCCH monitoring occasion for paging in the PF. When a parameter, firstPDCCH-MonitoringOccasionOfPO, is present, the starting PDCCH monitoring occasion number of (iₛ+1)^{th} PO is the (iₛ+1)^{th} value of the firstPDCCH-MonitoringOccasionOfPO parameter. If the parameter is not present, then the starting PDCCH monitoring occasion number is equal to iₛ*S*X. If X>1, when the UE detects a PDCCH transmission addressed to a paging radio network temporary identifier (P-RNTI) within a PO, then the UE does not monitor the subsequent PDCCH monitoring occasions for the PO.

In some cases, a PO associated with a PF may start in the PF or after the PF. Additionally, or alternatively PDCCH monitoring occasions for a PO can span multiple radio frames. When a value of the SearchSpaceId parameter is other than zero for a paging-SearchSpace, the PDCCH monitoring occasions for a PO can span multiple periods of the paging search space.

In some examples, the NE can use one or more parameters to calculate the PF and is for transmitting a paging message to a UE. Similarly, the UE may use the same one or more one or more parameters to calculate the PF and iₛ for receiving a paging message. The parameters can include a DRX cycle of the UE, T.

If the UE does not operate in extended DRX (eDRX), which has a longer inactive duration or OFF duration when compared with DRX, then T is determined by a shortest of the UE specific DRX values (e.g., if configured by RRC and/or upper layers or provided in sidelink (PC5)-RRC signaling in case of a L2 UE to network (U2N) relay UE) and a default DRX value broadcast in system information. In an RRC_IDLE state, if a UE specific DRX is not configured by upper layers, then a default value is applied.

In the RRC_IDLE state, if the UE operates in eDRX and eDRX is configured by upper layers (e.g., time eDRX (T_{eDRX.}), CN), and if T_{eDRX, CN} is no longer than a threshold numerical quantity of radio frames (e.g., 1024 radio frames), then T=T_{eDRX, CN}. If T_{eDRX, CN} is longer than the threshold numerical quantity of radio frames the CN determines the value of T when configuring a paging time window (PTW) by determining a shortest UE specific DRX value, if configured by upper layers, and the default DRX value broadcast in system information.

In an RRC_INACTIVE state, if the UE operates in eDRX and eDRX is configured by RRC (e.g., T_{eDRX, RAN}) and/or upper layers (e.g., T_{eDRX, CN}), and if both T_{eDRX, CN} and used T_{eDRX, RAN} are no longer than a threshold numerical quantity of radio frames (e.g., 1024 radio frames), then T=min{T_{eDRX, RAN}, T_{eDRX, CN}}. If T_{eDRX, CN} is no longer than the threshold numerical quantity of radio frames and T_{eDRX, RAN} is not configured or used, then T is determined by the shortest of UE specific DRX value configured by RRC and T_{eDRX, CN}.

If T_{eDRX, CN} is longer than the threshold numerical quantity of radio frames, and if T_{eDRX, RAN} is not configured or used, then during CN configured PTW, T is determined by the shortest of the UE specific DRX values, if configured by RRC and/or upper layers, and a default DRX value broadcast in system information. Outside the CN configured PTW, a NE can determine T using the UE specific DRX value configured by RRC.

In some cases, if T_{eDRX, RAN} is used and is no longer than the threshold numerical quantity of radio frames, during CN configured PTW, T is determined by the shortest of the UE specific DRX value, if configured by upper layers and T_{eDRX, RAN}, and a default DRX value broadcast in system information. Outside the CN configured PTW, T is determined by T_{eDRX, RAN}.

In some cases, N is a number of total paging frames in T, Nₛ is a number of POs for a PF, PF_{offset} is an offset used for PF determination, and the UE_{ID} depends on whether the UE operates in eDRX or not. If the UE operates in eDRX, then the UE_{ID} is a defined value (e.g., 5G system temporary mobile subscriber identity (5G-S-TMSI) mod 4096). If the UE does not operate in eDRX, then the UE_{ID} is a different defined value (e.g., 5G-S-TMSI mod 1024).

The values of the parameters Nₛ, nAndPagingFrameOffset, nrofPDCCH-MonitoringOccasionPerSSB-InPO, and a length of a default DRX cycle are signaled in SIB1. The values of N and PF_{offset} are derived from the parameter nAndPagingFrameOffset. The parameter firstPDCCH-MonitoringOccasionOfPO is signaled in SIB1 for paging in the BWP configured by initialDownlinkBWP. For paging in a downlink BWP other than the BWP configured by initialDownlinkBWP, the parameter first-PDCCH-MonitoringOccasionOfPO is signaled in the corresponding BWP configuration.

If there is no defined value for the UE_{ID} (e.g., if the UE has no 5G-S-TMSI), such as when the UE has not yet registered to a network, then the UE can use a default identity (e.g., UE_{ID}=0) in the PF and the iₛ in Equation 1 and Equation 2. In some cases, the UE_{ID} (e.g., 5G-S-TMSI) is a 48 bit long bit string and can be interpreted as a binary number where the left most bit represents the most significant bit.

In an RRC_INACTIVE state, if the UE supports inactiveStatePO-Determination and the network broadcasts ranPagingInIdlePO with a value of “true,” then the UE can use a same is as for an RRC_IDLE state. Otherwise, the UE determines the value of is using the parameters and Equations described herein. In an RRC_INACTIVE state, if an eDRX value configured by upper layers and used by the UE is no longer than a threshold numerical quantity of radio frames (e.g., 1024 radio frames), then the UE can use a same is as for RRC_IDLE state. In an RRC_INACTIVE state, an eDRX value configured by upper layers and used by the UE is longer than the threshold numerical quantity of radio frames, then during CN PTW, the UE can use a same iₛ as for the RRC_IDLE state. Outside CN PTW, the UE can use the iₛ for the RRC_INACTIVE state.

In some examples, a frequency of PFs can be decreased by extending the values of N to have increased interval between PFs (T/64, T/128, etc.) and compensating the decrease in the number of PFs by increasing POs per PF. However, the NE may transmit the same numerical quantity of transmissions since a total number of POs remains the same, leading to the same energy consumed by the NE.

As shown in FIG. 3, in some cases, conventional techniques for paging include transmission of an early paging indicator (PEI) 302 that indicates one or more POs that include paging messages. In the depicted embodiment, the POs include a first PO 304 (denoted as “PO #1”) and a second PO 306 (denoted as “PO #2”), as well as a third PO 308 (denoted as “PO #3”) and a fourth PO 310 (denoted as “PO #4”). For example, the PEI 302 provides for a subgroup of UEs to wake up and monitor for paging messages during at least one PO (e.g., the PO #1, the PO #2, the PO #3, and/or the PO #4). The NE can transmit the PEI 302 to the UE in a DCI message (e.g., DCI format 2_7). The PEI 302 can include codepoints for respective subgroups of UEs. A PO can include paging monitoring occasions (e.g., DCI 1_0 monitoring occasions).

In some examples, the NE may configure a UE with a bandwidth part (BWP) for initial access to a cell. As used herein, a cell refers to the geographic coverage area provided by a NE. A NE (e.g., gNB) can manage multiple cells, each operating on different frequencies or configurations, thereby providing coverage over a larger area and/or supporting different types of services. In some examples, each cell may be characterized by parameters such as frequency, bandwidth, and configuration of radio resources.

A BWP refers to a particular subset of the overall channel bandwidth within a carrier, allowing for flexible and efficient use of the frequency resources within the carrier. Additionally, energy saving is achieved by operating on a smaller BWP when full bandwidth is not needed, thereby reducing power consumption for transmitting and receiving/decoding signals. For example, the NE may dynamically enable a respective BWP based on user demand and/or network conditions. In some examples, the BWP may consist of at least one DL BWP and at least one UL BWP.

Moreover, for initial access to the cell, the UE may be configured with a set of default parameters that defines the initial BWP, i.e., the BWP that the UE uses to perform initial access procedures, e.g., when entering a cell or transitioning to the RRC_Connected mode. Initial access procedures include, but are not limited to, cell search, synchronization, random access, and connection establishment.

In various embodiments, the initial DL and UL BWPs are used at least for initial access before radio resource control (RRC) connection is established. An initial BWP has index zero and is referred to as BWP #0. The initial BWP carries essential common channels and signals required for initial access, such as the PDCCH, the physical downlink shared channel (PDSCH), the physical random access channel (PRACH), and the SIBs.

During the initial access, the UE performs cell search based on a SSB composed of the primary synchronization signal (PSS), the secondary synchronization signal (SSS), and the PBCH. To access the system, the UE needs to further read the SIB1, which carries important information including the initial DL/UL BWP configuration. The SIB1 is transmitted on the PDSCH, which is scheduled by downlink control information (DCI) on the PDCCH using the control resource set with index zero (CORESET #0). As used herein, the control resource set (CORESET) refers to the time-frequency resources within a BWP where the PDCCH can be located. A cell may have multiple CORESETs. In some examples, each CORESET may be defined by several parameters, including the number of OFDM symbols, the frequency domain location, and the time domain allocation.

Before the UE reads the SIB1, the UE's initial DL BWP has the same frequency range and numerology as those of CORESET #0. After reading the SIB1 (which may be broadcast in CORESET #0), the UE follows the initial DL/UL BWP configuration in the SIB1 and uses them to carry out random-access procedure to request the setup of RRC connection. In some examples, the NE configures (e.g., assigns or designates) the frequency domain location and bandwidth of the initial DL BWP in the SIB1 so that the initial DL BWP contains the entire CORESET #0 in the frequency domain.

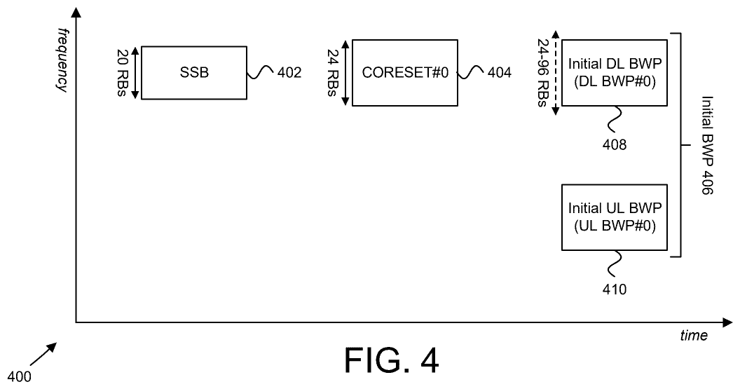

FIG. 4 depicts an exemplary transmission diagram 400 for the initial BWP, in accordance with aspects of the present disclosure. In some examples, the transmission diagram 400 is implemented by aspects of the wireless communications system 100, for example, implemented by a UE and a NE, which may be examples of a UE 104 and a NE 102 as described with reference to FIG. 1.

As shown in FIG. 4, the initial BWP operation may include transmission of the SSB 402, e.g., over 20 resource blocks (RBs). As used herein, a resource block (RB) is a unit of resource allocation in the frequency domain consisting of a fixed number of consecutive subcarriers. In 5G NR, the RB typically spans 12 subcarriers, and the bandwidth of the RB depends on the subcarrier spacing used in the 5G NR system. For example, for 15 kHz subcarrier spacing, the bandwidth of one RB is 180 kHz, while for 30 kHz subcarrier spacing, the bandwidth of one RB is 360 kHz. Similarly, for 60 kHz subcarrier spacing, the bandwidth of one RB is 720 kHz, while for 120 kHz subcarrier spacing, the bandwidth of one RB is 1.44 MHz.

The duration of an RB in time is one slot, which may be composed of, e.g., 14 OFDM symbols in the time domain. In 5G NR, the time duration of an RB is based on the slot duration, which may vary according to the numerology and subcarrier spacing used. For example, for 15 kHz subcarrier spacing, the time duration of one RB (i.e., slot duration) is 1 ms, while for 30 kHz subcarrier spacing, the time duration of one RB (slot duration) is 0.5 ms. Similarly, for 60 kHz subcarrier spacing, the time duration of one RB (i.e., slot duration) is 0.25 ms, while for 120 kHz subcarrier spacing, the time duration of one RB (slot duration) is 0.125 ms.

In addition to the SSB 402, the initial BWP operation may include the transmission of the CORESET #0 404, e.g., over 24 RBs. Additionally, the initial BWP operation may include transmissions over the initial BWP 406, comprising the initial DL BWP 408 and the initial UL BWP 410. In some examples, the initial BWP 406 spans 24 to 96 RBs.

Certain wireless communication systems may support UEs with different bandwidth capabilities, including wideband UEs (WB-UEs) and bandwidth limited UEs (BL-UEs). However, legacy systems, such as LTE networks, have different physical channels for the BL-UEs and the WB-UEs. Under this design, the NE must transmit duplicate information over each set of physical channels, i.e., one copy of SSB transmitted on the physical channels for the BL-UEs and a different copy on the physical channels for the WB-UEs, which results in extra emissions and energy consumption.

To improve network energy savings, the present disclosure describes a unified common channel framework for the different types of UEs, e.g., BL-UEs and WB-UEs. The unified common channel enables the NE to efficiently transmit the common channel in an efficient manner in a cell. In certain embodiments, the common channel may be a common control channel, e.g., associated with paging and/or RACH resources.

In various embodiments, the common channel, e.g., SSB, CORESET #0, SIB1 and paging channel, is mapped in an initial common BWP during initial access according to the bandwidth supported by device type, i.e., BL-UE and WB-UE. Accordingly, the paging and ROs are mapped according to the supported bandwidth.

In some examples, a respective BL-UE may receive the common channel, i.e., paging, and transmit RACH in a narrowband resource within the initial BWP whose frequency range is same as that of the CORESET #0, SSB, etc. In some examples, a respective WB-UE may receive the common channel, i.e., paging, and transmit RACH in a wideband resource within the initial BWP whose paging and RACH resources may be, frequency division multiplexed (FDMed), or time division multiplexed (TDMed), or overlapping with that of the BL-UE resource.

In some embodiments, a NE becomes aware of the UE type (e.g., bandwidth capability) during the initial access and/or registration phase. Moreover, the NE may indicate the resource configurations per device type in SIB1. For example, the SIB1 may provide separate resource configuration for each device type according to its maximum supported bandwidth within the initial BWP. Here, a respective BL-UE may have a maximum supported bandwidth equal to that of the SSB and/or CORESET #0 (e.g., 20 or 24 RBs). In contrast, the WB-UE may have a maximum supported bandwidth equal to that of the carrier bandwidth, for example, 100 MHz, 400 MHZ, etc.

According to aspects of a first solution, in the unified common channel framework for different device types, such as the BL-UE type and the WB-UE type, the BL-UE may receive the common channel, e.g., SSB, CORESET #0, SIB1, and paging channel, within the frequency range of initial BWP. In some examples, the bandwidth associated with the common channel (e.g., within the initial BWP) does not exceed the BL-UE maximum bandwidth capability. Accordingly, the NE (e.g., base station and/or gNB) may configure (e.g., set up, deploy, or provision) the common channel resource (e.g., paging and RACH) of the BL-UE in the initial BWP within its maximum supported bandwidth.

However, the WB-UE may receive the common channel within a wider initial BWP than the BL-UE. Therefore, the NE (e.g., base station and/or gNB) may configure the common channel resource (e.g., paging and RACH) of the WB-UE in a wider initial BWP, which encompasses the initial BWP of the BL-UE. In some examples, the BL-UE definition of maximum supported bandwidth may be equal to the SSB bandwidth or CORESET #0 bandwidth, which could be equal to 5 MHz. However, the WB-UE definition of maximum supported bandwidth may be equal to or less than the carrier bandwidth, while still greater than the BL-UE maximum bandwidth.

In some embodiments, the NE may utilize the same time-domain occasion to configure (e.g., allocate or designate) different FDMed resources according to the maximum supported bandwidth BL-UE and WB-UE. For example, the NE may configure the resource for paging and RACH for BL-UE and WB-UE within an FDMed resource configuration, wherein the BL-UE resources are found according to the bandwidth supported by the BL-UE.

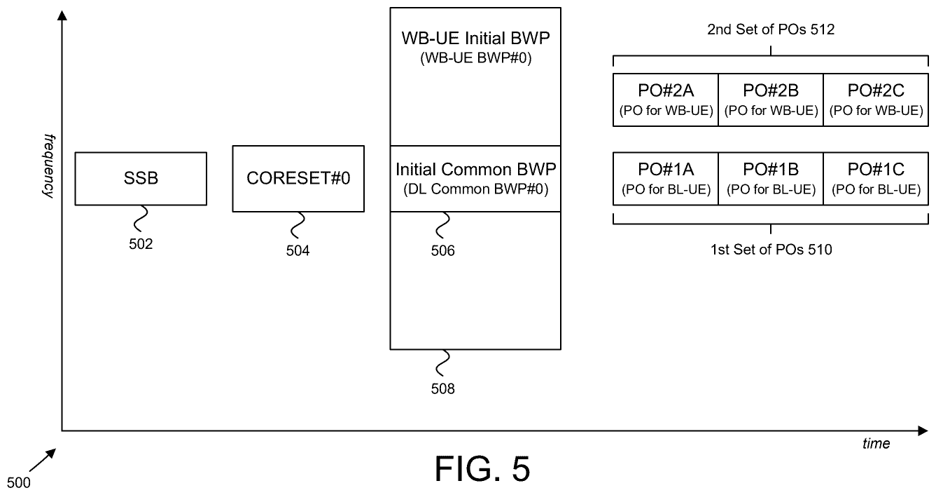

FIG. 5 depicts an exemplary configuration 500 of an initial BWP for different device types, in accordance with aspects of the present disclosure. In some embodiments, different device types include the BL-UE and WB-UE described above. As illustrated, the SSB 502 and CORESET #0 504 are located in the same frequency resources as the initial common BWP 506, which corresponds to a common DL BWP (i.e., BWP #0) of both the BL-UE devices and the WB-UE devices. Here, the WB-UE devices may additionally support a wider initial bandwidth BWP 508 that encompasses the initial common BWP 506.

Moreover, the NE may configure (e.g., establish) resources for paging and RACH for BL-UE and WB-UE in accordance with their device type capability, e.g., supported maximum bandwidth, as shown in FIG. 5. For example, the NE may configure a first set of POs 510 (depicted as PO #1A, PO #1B, PO #1C) for the BL-UEs using frequency resources that correspond to the initial common BWP 506. In certain embodiments, the first set of POs 510 may be dedicated for use by the BL-UEs, such that the NE only allocates POs of the first set of POs 510 to the BL-UEs. Additionally, the NE may configure a second set of POs 512 (depicted as PO #2A, PO #2B, PO #2C) for the WB-UEs using frequency resources that are within the wider initial bandwidth BWP 508, but outside the initial common BWP 506. In the depicted embodiment, the first set of POs 510 are FDMed with the second set of POs 512, meaning that they share the same time-domain resources, but utilize different frequency-domain resources.

In various embodiments, the NE may transmit a SIB1 containing resource configuration information for paging and RACH for different device types. In some embodiments, the SIB1 may contain resource configuration for the FDMed POs for different device types, such as BL-UE and WB-UE. In certain embodiments, a PO for a respective BL-UE may be configured within an FDMed resource according to the bandwidth of the SSB or CORESET #0, while the rest of the FDMed resources within the same time occasion may be configured for the WB-UE.

In one implementation, a respective BL-UE may be configured with resources within the maximum supported bandwidth of the BL-UE and hence from the BL-UE perspective the paging and RACH channel resources within each of its occasions are not FDMed. However, from the system perspective the resources are FDMed such that the device-type specific (e.g., supported maximum bandwidth aware) configuration from SIB1 distinguish such resources for the BL-UEs and the WB-UEs.

In some examples, the SIB1 may contain device specific configuration implying separate resource configuration field for the BL-UEs and the WB-UEs. In such an approach, the configuration for a respective BL-UE may indicate time domain multiplexing (TDM) paging or ROs whose frequency range may be within the maximum supported bandwidth of the BL-UE.

In some implementations, a WB-UE device may be configured with resources FDMed with the BL-UE resources, where the WB-UE resources are beyond the maximum supported bandwidth of the BL-UE device(s). For example, in the case of a BL-UE configured for narrowband (NB) low-power wide area network (WAN), the NE may configure (e.g., designate) the paging resource, the CORESET #0 and the RACH resources for such NB devices within a synchronization signal and PBCH (SS/PBCH) bandwidth, e.g., 1 RB within a SSB (SS/PBCH) bandwidth. Additionally, in such implementations, the NE may configure the WB-UE(s) with paging resource(s) and a CORESET #0 occupying several RBs, which can be FDMed with that of the NB paging resource, i.e., the 1 RB paging, CORESET #0 and RACH resources, respectively.

In some examples, the NB BL-UE can have a system bandwidth of 5 MHz (i.e., equal to the SSB bandwidth), however, the NE configures the bandwidth of CORESET #0, paging and RACH resource to be even smaller than the SSB bandwidth, for example, 1 RB (corresponding to 180 kHz for a subcarrier spacing value of 15 kHz). In certain implementations, the CORESET #0 may be TDMed with the SSB block. In one example, the CORESET #0 resource for BL-UE(s) (e.g., 1 RB) may be configured within the wider CORESET #0 resource for the WB-UE(s), thereby the NE may avoid configuring a separate CORESET #0 transmission for the BL-UEs.

In one implementation, the lowest RB starting position from the wider CORESET #0 bandwidth (e.g., the lowest RB within the SSB Bandwidth) may be assigned to the BL-UE(s), i.e., as the monitoring occasion for the PDCCH search space. In such an implementation, the BL-UE PDCCH can be configured within the PDCCH search space configured for BL-UE. Hence, in certain implementations, the NE may configure (e.g., provision) at least two common search spaces within CORESET #0, one each for the BL-UE(s) and the WB-UE(s), where each common search space is device specific and signaled using separate PDCCH-ConfigSIB1 transmissions.

In another implementation, the NE may configure a fixed RB position within the SSB bandwidth (e.g., from the wider CORESET #0 associated with the WB-UE(s)) as a BL-UE PDCCH common search space. In such an embodiment, the indication of that fixed-position RB, or an indication of a table index to derive starting RB, can be signaled by the NE, e.g., using a PBCH payload, the maximum supported bandwidth of a device type, frequency band, or a combination thereof.

In some examples, the combination of frequency band and maximum supported bandwidth of a device may result in a plurality of tables, where each table indicates at least a starting RB and a CORESET #0 bandwidth. In one embodiment, the NE may signal the table index can be signaled using PBCH payload separately for each device type, e.g., using the PBCH payload. Alternatively, the UE may select a table for a frequency band for receiving the SSB from plurality of tables, where each table may contain values for the starting RB of the common search space or the CORESET #0, or a combination thereof. In certain embodiments, the CORESET #0 bandwidth or common search space bandwidth within a CORESET #0 for each device type may be according to the maximum supported bandwidth of each device types. Here each UE of a respective device type can select a table index according to the device specific support of maximum bandwidth.

In alternative implementations, the NE may configure (e.g., allocate) a separate CORESET #0 for the BL-UE(s) in addition to the CORESET #0 for the WB-UE(s). In such embodiments, however, the NE may use separate fields in the PBCH payload to indicate the starting location and bandwidth of the CORESET #0 for each of these device types.

In some implementations, the NE may configure a separate SSB-RACH mapping rule for each of these device types (i.e., BL-UE and WB-UE) since a PRACH transmission by a BL-UE may be transmitted using a narrower bandwidth compared to that of the PRACH transmission from a WB-UE.

In one implementation, the size of the initial common BWP 506 may be restricted to the size of the CORESET #0, SSB, etc. Within such an initial common BWP, various options exist for allocating resource occasions.

Option #1: Only the BL-UE may be allocated resource occasions for paging and RACH within the bandwidth of the initial common BWP 506. Accordingly, the NE may configure a separate dedicated BWP for the WB-UE with paging and ROs that are FDMed with those allocated for the BL-UE. In such embodiments, the SIB1 may contain a dedicated BWP configuration for the WB-UE. Additionally, in some instances, based on the information available at the CN, the CN may signal a RAT type along with the paging message to the NE (e.g., a gNB) and the NE may map the paging resource for the WB-UE and BL-UE separately using the RAT type indicator. In certain embodiments, the CN may initially receive the information on the RAT type from registration, then store and download the RAT type information from the unified data management (UDM). Alternatively, the NE (e.g., a gNB) may configure a paging burst, where a bitmap of POs may be configured for BL-UE and WB-UE using TDM.

Option #2: Both the BL-UE and the WB-UE may utilize the resources for paging and RACH within the initial common BWP 506; however, the BL-UE may be restricted to utilizing the resource within its maximum supported bandwidth, which may be equal to that of the SSB, CORESET #0, etc., while the WB-UE may utilize both common resources configured for BL-UE and WB-UE and such resources (FDMed at the system-level) within the same paging or ROs.

Option #3: A subset of the paging and ROs in the time domain configured in the initial common BWP 506 may be applicable for BL-UEs. For example, the paging and ROs in the initial common BWP 506 may be TDMed for BL-UE utilization. Optionally, one or more additional resources FDMed within the same occasions may be utilized by a WB-UE.

Option #4: A non-cell defining SSB or SSBs configured outside of the frequency raster may be applicable for WB-UE or BL-UE as part of a separate dedicated BWP to provide a separate paging, RACH resource and corresponding PDDCH and physical uplink shared channel (PUSCH) resources during initial access. Such configuration may be provided using SIB1.

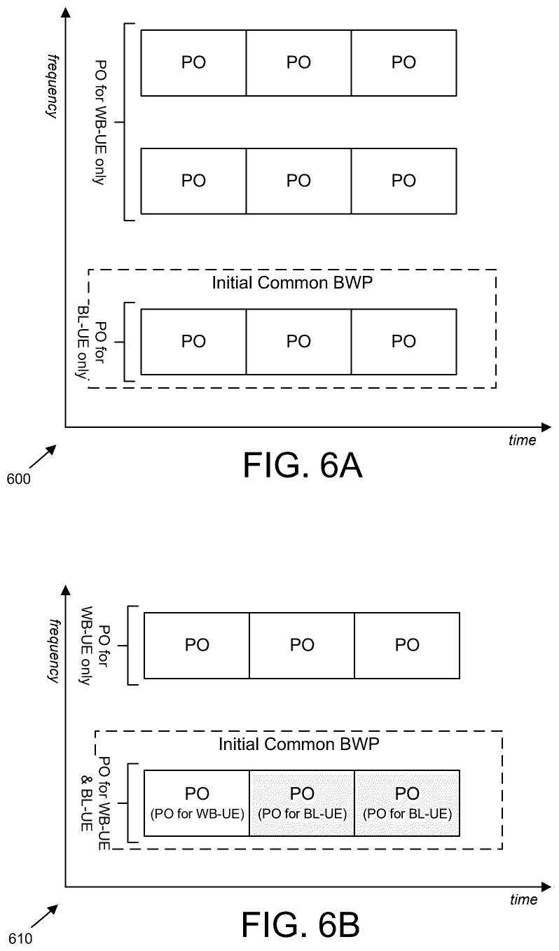

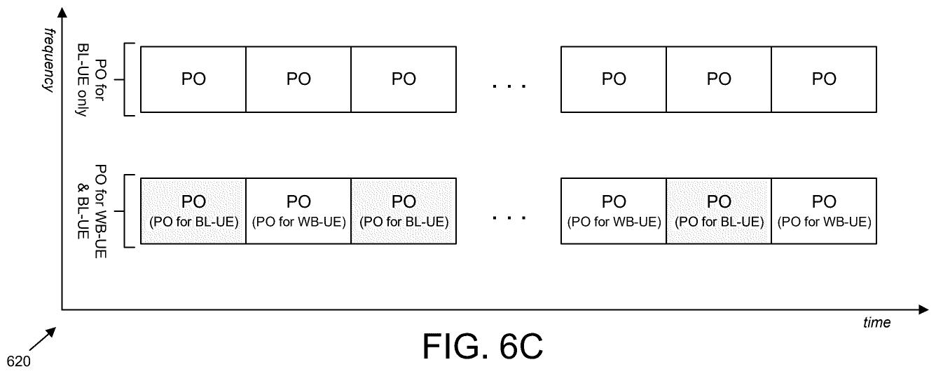

FIGS. 6A, 6B and 6C depict different options for allocating POs within the bandwidth of an initial common BWP. FIG. 6A depicts a first allocation scheme 600, where the POs located within the initial common BWP are allocated only to BL-UEs, while FDMed POs located outside of the initial common BWP are allocated to the WB-UEs.

FIG. 6B depicts a second allocation scheme 610, where the POs located within the initial common BWP may be allocated to the WB-UEs and to the BL-UEs, while FDMed POs located outside of the initial common BWP are allocated to the WB-UEs.

FIG. 6C depicts a third allocation scheme 620, where the POs located within the initial common BWP may be allocated to the BL-UEs in a TDM manner, while others of the TDMed POs in the initial common BWP and the FDMed POs located outside of the initial common BWP are allocated to the WB-UEs.

According to aspects of a second solution, to reduce power consumption at a NE due to transmitting paging messages, a NE may use multi-stage DCI to indicate a FDMed PO, in accordance with aspects of the present disclosure. For example, a two-stage DCI design may be used for the PO, where the first-stage DCI may indicate the resources for the plurality of second stage DCI transmitted together with the PDSCH. However, a paging message for a particular UE does not need to be transmitted in multiple POs, and it is beneficial to indicate which FDMed PO the UE should decode, therefore the UE needs to determine which FDMed PO to monitor and decode.

In some implementations, the NE transmits, to a UE, a DCI configuration message for configuring a first-stage DCI and a set of second-stage DCI associated with a paging message. Here, the DCI configuration message may indicate the multi-stage DCI transmission scheme for paging, where a first-stage DCI indicates at least one second-stage DCI located within respective POs.

In such implementations, the UE may receive, based on a first time-frequency resource, the first-stage DCI including one or more parameters that indicate a set of second time-frequency resources associated with the set of second-stage DCI, where the set of second-stage DCI is FDMed in respective POs associated with the paging message. Subsequent to receiving the first-stage DCI, the UE selects a second time-frequency resource (e.g., PO) based on a paging formula, and monitors for the associated second-stage DCI based on the selected second time-frequency resource.

The multi-stage DCI scheme for FDMed POs is described in greater detail in U.S. patent application Ser. No. 18/759,772, entitled “DOWNLINK CONTROL INFORMATION FOR MULTIPLEXED PAGING OCCASIONS” filed on Jun. 28, 2024, for Karthikeyan Ganesan, Ravi Kuchibhotla, and Abdul Rasheed Mohammed, the entirety of which is incorporated by reference.

In various embodiments, the NE and UEs may utilize a UE specific paging formula to determine which FDMed PO contains the associated second-stage DCI, to avoid the UE having to decode all FDMed POs which consumes lot of power and may cause memory constraints at the UE side. Each UE in the idle mode may derive its own paging occasion within the FDMed POs (denoted as “POFDM”) according to the paging formula of Equation 3 which is explained in an exemplary example.

$${PO}_{FDM} = floor ( \frac{{UE}_{ID}}{N \times {N}_{s}} ) mod ( {Num}_{FDMed \_ PO} ) . \qquad ( 3 )$$

In Equation 3, the UE's PO (within the FDMed POs) is represented by POFDM. The UE's identity is represented by UE_{ID}, which may be derived as the UE's 5G System Temporary Mobile Subscriber Identity (5G-S-TMSI) modulo 1024. The variable N represents the number of paging frames in a DRX cycle of RRC Idle mode. The variable Ns represents the number of POs for a PF. The variable Num_{FDM_PO} represents the number of FDMed POs configured in a time-domain PO.

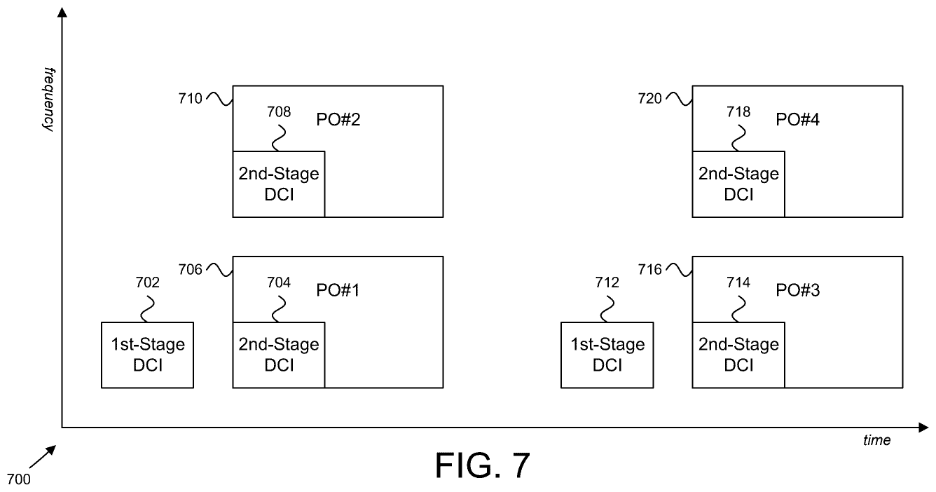

FIG. 7 depicts a transmission diagram 700 for multi-stage DCI for paging with FDMed POs, in accordance with aspects of the present disclosure. The transmission diagram may be implemented by an NE 102 transmitting to one or more UEs 104, which may be examples of UEs 104, and a NE 102 as described with reference to FIG. 1. The NE 102 may be an example of a base station and/or a serving cell. In some examples, the NE 102 can transmit signaling, such as control signaling and/or data, to UEs within a coverage area of the NE 102, which can include the UEs 104 and/or one or more additional UEs.

The UEs 104 can monitor for the DCI messages during an active period of a DRX cycle in an inactive mode and/or an idle mode (e.g., during scheduled time-frequency resources). In some examples, to reduce a duration the NE 102 and/or the UEs 104 spend monitoring for paging messages in an inactive mode and/or the idle mode and a corresponding power consumption of the NE 102 and/or the UEs 104 in the inactive mode and/or the idle mode, the NE 102 can perform frequency division multiplexing (FDM) and/or TDM of one or more POs in a PF.

In some cases, a first PO 706 (denoted as “PO #1”) and a second PO 710 (denoted as “PO #2”), as well as a third PO 716 (denoted as “PO #3”) and a fourth PO 720 (denoted as “PO #4”), respectively, can be FDMed. For example, the first PO 706 and the second PO 710 share overlapping resources in the time domain and are allocated different resources in the frequency domain. Similarly, the third PO 716 and the fourth PO 720 share overlapping resources in the time domain and are allocated different resources in the frequency domain.

In some examples, a numerical quantity of POs FDMed in a slot allocated for paging can be semi-statically configurable (e.g., via RRC signaling and/or via a MAC control element (MAC-CE)). For example, the NE 102 may transmit a configuration message that includes one or more parameters that indicate the numerical quantity of POs FDMed in a slot allocated for paging information. The NE 102 can transmit one or more messages including first-stage DCI 702, 712 to the UEs 104 to indicate a location in the time domain and the frequency domain of the POs.

By using FDM techniques to transmit paging messages in POs that share a same resource in the time domain, a NE 102 can deliver the paging messages over a shorter duration when compared with POs that are distributed across the time domain, as described with reference to FIG. 2. Thus, the NE 102 can transmit the paging messages over the shorter duration, and then can enter an inactive mode or idle mode, which leads to reduced power consumption at the NE 102.

In some examples, the first-stage DCI 702, 712 may be transmitted in a common control channel, i.e., a PDCCH search space dedicated for paging, a common search space, or any combination thereof belonging to a common CORESET, paging dedicated CORESET, CORESET #0, among others.

In some examples, to reduce processing and latency related to blind decoding D the first-stage DCI 702, 712 in respective monitoring occasions for the POs, the NE 102 can configure a multi-stage DCI transmission scheme (e.g., with two or more different types of messages including DCI) to indicate the POs that are FDMed and/or TDMed. Blind decoding is a process in which the UE 104 attempts to decode the DCI without prior knowledge of transmission parameters of the DCI, such as a modulation and coding scheme (MCS), coding rate, or the position of the transmission in the time domain and the frequency domain.

For example, the NE 102 can configure the UE to monitor for a first-stage DCI 702, 712 that is scrambled with a P-RNTI, where the first-stage DCI 702, 712 indicates at least one second-stage DCI 704, 708, 714, 718 located within respective POs 706, 710,716, 720. In certain embodiments, the NE 102 transmits the first-stage DCI 702, 712 in a PDCCH search space and transmits the second-stage DCI 704, 708, 714, 718 as part of (e.g., within) a physical downlink shared channel (PDSCH) resource of each FDMed PO. Each second-stage DCI 704, 708, 714, 718 can be transmitted together with the PDSCH and within each of the FDMed POs and/or PDSCH in a slot. Each of the second-stage DCI 704, 708, 714, 718 can include scheduling information, such as a MCS, that the UEs 104 can use to decode the corresponding PDSCH including a paging message. Additionally, or alternatively, second-stage DCI 704, 708, 714, 718 can include a short messaging payload for the UEs 104. The first-stage DCI 702, 712, which is included in a PDCCH, may be transmitted in a paging search space, a common search space of a common CORESET, a dedicated CORESET for paging, a CORESET #0, or any combination thereof.

In some variations, the NE 102 can configure a new monitoring occasion mapping scheme between a first-stage DCI 702, 712 and one or more second-stage DCI 704, 708, 714, 718 in a PO, such that the one or more FDMed POs in a slot of a PF and/or TDMed POs in multiple slots can be represented by a number of POs per first-stage DCI. The number of POs per first-stage DCI can be configured by a higher layer parameter (e.g., in RRC signaling and/or a MAC-CE).

In certain embodiments, the first-stage DCI 702, 712 can indicate the monitoring occasions for the second-stage DCI 704, 708, 714, 718. In some other variations, the NE 102 can configure a mapping between multiple monitoring occasions for the first-stage DCI 702, 712 to one or more groups of FDMed POs or groups of second-stage DCI. The mapping can be represented by a number of POs per first-stage DCI and can be configured by a higher layer parameter. The monitoring occasions for the first-stage DCI 702, 712 can be in the same or different search space, CORESETs, time slots, FDMed in same time slot, or any combination thereof.

In some examples, if the POs are FDMed, then the first-stage DCI 702, 712 can include a parameter that indicates a time resource (e.g., a slot) of the FDMed POs. The parameter can include a time resource indicator value (TRIV), and the POs can share the time resources. The first-stage DCI 702, 712 can include one or more parameters that indicate respective frequency resources of the FDMed POs. The parameters can include a frequency resource indicator value (FRIV) that indicates a starting RB index (e.g., a lowest RB starting position) of the second-stage DCI 704, 708, 714, 718. The FRIV can encode a frequency domain offset of the second-stage DCI 704, 708, 714, 718, where the offset granularity for the FRIV indication can be configured in terms of RBs or RB groups (RBGs) including N physical RBs (PRBs) or a subchannel including N PRBs. In some cases, the UEs 104 can estimate an offset of one or more second-stage DCI 704, 708, 714, 718 using a frequency domain location of an initial second-stage DCI.

Moreover, using the above formula, the UE may select one of the FDMed POs 706, 710, 716, 720 within plurality of FDMed POs in a time slot, thereby avoiding the decoding of all FDMed POs in the relevant time-domain PO.

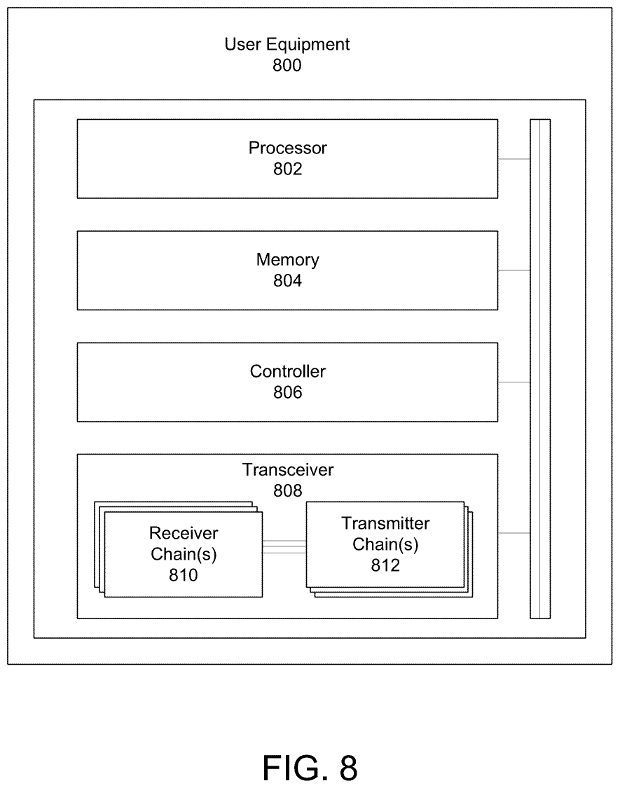

FIG. 8 illustrates an example of a UE 800 in accordance with aspects of the present disclosure. The UE 800 may include a processor 802, a memory 804, a controller 806, and a transceiver 808. The processor 802, the memory 804, the controller 806, or the transceiver 808, or various combinations thereof or various components thereof may be examples of means for performing various aspects of the present disclosure as described herein. These components may be coupled (e.g., operatively, communicatively, functionally, electronically, electrically) via one or more interfaces.

The processor 802, the memory 804, the controller 806, or the transceiver 808, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 802 may include an intelligent hardware device (e.g., a general-purpose processor, a DSP, a central processing unit (CPU), an ASIC, a field programmable gate array (FPGA), or any combination thereof). In some implementations, the processor 802 may be configured to operate the memory 804. In some other implementations, the memory 804 may be integrated into the processor 802. The processor 802 may be configured to execute computer-readable instructions stored in the memory 804 to cause the UE 800 to perform various functions of the present disclosure.

The memory 804 may include volatile or non-volatile memory. The memory 804 may store computer-readable, computer-executable code including instructions that, when executed by the processor 802, cause the UE 800 to perform various functions described herein. The code may be stored in a non-transitory computer-readable medium such the memory 804 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 802 and the memory 804 coupled with the processor 802 may be configured to cause the UE 800 to perform one or more of the UE functions described herein (e.g., executing, by the processor 802, instructions stored in the memory 804). Accordingly, the processor 802 may support wireless communication at the UE 800 in accordance with examples as disclosed herein. For example, the UE 800 may be configured to support a means for indicating, to a serving base station, a supported bandwidth, wherein the UE either supports wideband operation, or is a bandwidth-limited UE.

The UE 800 may be configured to support a means for receiving, from the base station, a configuration message indicating the common channel monitoring resource, where the common channel monitoring resource is associated with a set of POs and a set of ROs. In some embodiments, the UE 800 is configured to receive the configuration message in a SI message. In certain embodiments, the configuration message may be a device-specific configuration message.

In some embodiments, the common channel monitoring resource is based at least in part on an initial BWP for initial access to the base station and a set of one or more bandwidths supported by one or more UEs served by the base station.

In some embodiments, the set of POs comprises a first set of POs within the initial BWP and a second set of POs outside the initial BWP. In such embodiments, the first set of POs are frequency-division multiplexed with the second set of POs.

In some embodiments, the set of ROs comprises a first set of ROs within the initial BWP and a second set of ROs outside the initial BWP. In such embodiments, the first set of ROs are frequency-division multiplexed with the second set of ROs.

In some embodiments, the common channel monitoring resource is further based at least in part on an initial BWP corresponding to a maximum supported bandwidth associated with the bandwidth-limited UE. In certain embodiments, the initial BWP corresponds to a bandwidth of a SSB for a cell serving the plurality of UEs, or a bandwidth of a CORESET #0 of the cell, or both.

In some embodiments, the UE 800 supports wideband operation and is configured to receive, in a respective PO of the set of POs, a first paging message. In such embodiments, the first paging message is transmitted on a frequency resource that is outside of the common channel monitoring resource.

In some embodiments, the UE 800 is further configured to receive a first DCI message (e.g., including first-stage DCI) and determine a first PO. In such embodiments, the UE 800 is further configured to receive a second DCI message (e.g., including second-stage DCI) in the first PO, where a plurality of POs corresponds to different frequency resources during a same time period.

In certain embodiments, to determine the first PO, the UE 800 is configured to select the first PO based at least in part on an identifier of the UE 800 and a number of the plurality of POs corresponding to the same time period.

The controller 806 may manage input and output signals for the UE 800. The controller 806 may also manage peripherals not integrated into the UE 800. In some implementations, the controller 806 may utilize an operating system (OS) such as iOS®, ANDROID®, WINDOWS®, or other operating systems. In some implementations, the controller 806 may be implemented as part of the processor 802.

In some implementations, the UE 800 may include at least one transceiver 808. In some other implementations, the UE 800 may have more than one transceiver 808. The transceiver 808 may represent a wireless transceiver. The transceiver 808 may include one or more receiver chains 810, one or more transmitter chains 812, or a combination thereof.

A receiver chain 810 may be configured to receive signals (e.g., control information, data, packets) over a wireless medium. For example, the receiver chain 810 may include one or more antennas for receiving the signal over the air or wireless medium. The receiver chain 810 may include at least one amplifier (e.g., a low-noise amplifier (LNA)) configured to amplify the received signal. The receiver chain 810 may include at least one demodulator configured to demodulate the received signal and obtain the transmitted data by reversing the modulation technique applied during transmission of the signal. The receiver chain 810 may include at least one decoder for decoding/processing the demodulated signal to receive the transmitted data.

A transmitter chain 812 may be configured to generate and transmit signals (e.g., control information, data, packets). The transmitter chain 812 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 812 may also include at least one power amplifier configured to amplify the modulated signal to an appropriate power level suitable for transmission over the wireless medium. The transmitter chain 812 may also include one or more antennas for transmitting the amplified signal into the air or wireless medium.

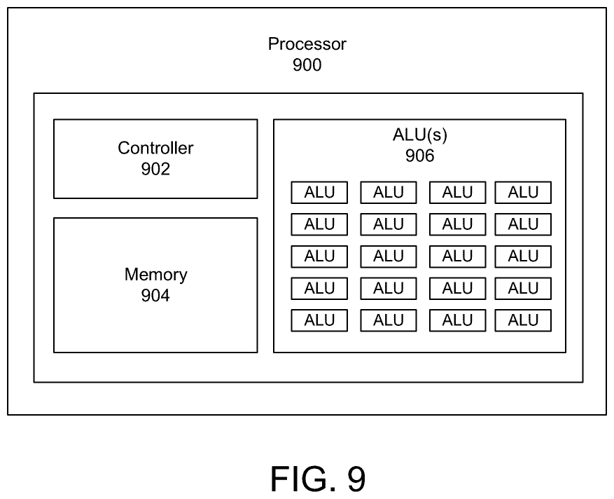

FIG. 9 illustrates an example of a processor 900 in accordance with aspects of the present disclosure. The processor 900 may be an example of a processor configured to perform various operations in accordance with examples as described herein. The processor 900 may include a controller 902 configured to perform various operations in accordance with examples as described herein. The processor 900 may optionally include at least one memory 904, which may be, for example, an L1/L2/L3 cache. Additionally, or alternatively, the processor 900 may optionally include one or more arithmetic-logic units (ALUs) 906. One or more of these components may be in electronic communication or otherwise coupled (e.g., operatively, communicatively, functionally, electronically, electrically) via one or more interfaces (e.g., buses).

The processor 900 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 900) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 902 may be configured to manage and coordinate various operations (e.g., signaling, receiving, obtaining, retrieving, transmitting, outputting, forwarding, storing, determining, identifying, accessing, writing, reading) of the processor 900 to cause the processor 900 to support various operations in accordance with examples as described herein. For example, the controller 902 may operate as a control unit of the processor 900, generating control signals that manage the operation of various components of the processor 900. These control signals include enabling or disabling functional units, selecting data paths, initiating memory access, and coordinating timing of operations.

The controller 902 may be configured to fetch (e.g., obtain, retrieve, receive) instructions from the memory 904 and determine subsequent instruction(s) to be executed to cause the processor 900 to support various operations in accordance with examples as described herein. The controller 902 may be configured to track memory address of instructions associated with the memory 904. The controller 902 may be configured to decode instructions to determine the operation to be performed and the operands involved. For example, the controller 902 may be configured to interpret the instruction and determine control signals to be output to other components of the processor 900 to cause the processor 900 to support various operations in accordance with examples as described herein. Additionally, or alternatively, the controller 902 may be configured to manage flow of data within the processor 900. The controller 902 may be configured to control transfer of data between registers, arithmetic logic units (ALUs), and other functional units of the processor 900.

The memory 904 may include one or more caches (e.g., memory local to or included in the processor 900 or other memory, such RAM, ROM, DRAM, SDRAM, SRAM, MRAM, flash memory, etc. In some implementations, the memory 904 may reside within or on a processor chipset (e.g., local to the processor 900). In some other implementations, the memory 904 may reside external to the processor chipset (e.g., remote to the processor 900).

The memory 904 may store computer-readable, computer-executable code including instructions that, when executed by the processor 900, cause the processor 900 to perform various functions described herein. The code may be stored in a non-transitory computer-readable medium such as system memory or another type of memory. The controller 902 and/or the processor 900 may be configured to execute computer-readable instructions stored in the memory 904 to cause the processor 900 to perform various functions. For example, the processor 900 and/or the controller 902 may be coupled with or to the memory 904, the processor 900, the controller 902, and the memory 904 may be configured to perform various functions described herein. In some examples, the processor 900 may include multiple processors and the memory 904 may include multiple memories. One or more of the multiple processors may be coupled with one or more of the multiple memories, which may, individually or collectively, be configured to perform various functions herein.

The one or more ALUs 906 may be configured to support various operations in accordance with examples as described herein. In some implementations, the one or more ALUs 906 may reside within or on a processor chipset (e.g., the processor 900). In some other implementations, the one or more ALUs 906 may reside external to the processor chipset (e.g., the processor 900). One or more ALUs 906 may perform one or more computations such as addition, subtraction, multiplication, and division on data. For example, one or more ALUs 906 may receive input operands and an operation code, which determines an operation to be executed. One or more ALUs 906 be configured with a variety of logical and arithmetic circuits, including adders, subtractors, shifters, and logic gates, to process and manipulate the data according to the operation. Additionally, or alternatively, the one or more ALUs 906 may support logical operations such as AND, OR, exclusive-OR (XOR), not-OR (NOR), and not-AND (NAND), enabling the one or more ALUs 906 to handle conditional operations, comparisons, and bitwise operations.

In various implementations, the processor 900 may support the functions of a UE, in accordance with examples as disclosed herein. For example, the processor 900 may be configured to support a means for indicating, to a serving base station, a supported bandwidth, wherein the UE either supports wideband operation, or is a bandwidth-limited UE. In one embodiment, the UE is a WB-UE, i.e., supporting wideband operation. In another embodiment, the UE is a BL-UE, i.e., having a limited bandwidth (e.g., as compared to the WB-UE).

The processor 900 may be configured to support a means for receiving, from the base station, a configuration message indicating a common resource for channel monitoring, where the common channel monitoring resource is associated with a set of POs and a set of ROs. In some embodiments, the processor 900 is configured to receive the configuration message in a SI message. In certain embodiments, the configuration message may be a device-specific configuration message.

In some embodiments, the common resource for channel monitoring is based at least in part on an initial BWP for initial access to the base station and a set of one or more bandwidths supported by the UEs served by the base station.

In some embodiments, the initial BWP includes the set of POs comprising a first subset of POs, wherein the initial BWP excludes a second subset of POs of the set of POs. In such embodiments, the first subset of POs and the second subset of POs may be FDMed.

In some embodiments, the initial BWP includes the set of ROs comprising a first subset of ROs, wherein the initial BWP excludes a second subset of ROs of the set of ROs. In such embodiments, the first subset of ROs and the second subset of ROs may be FDMed.

In some embodiments, the common resource for channel monitoring is configured based at least in part on an initial BWP corresponding to a maximum supported bandwidth associated with the UE. In certain embodiments, the initial BWP is equal to a bandwidth associated with a SSB for a cell serving the plurality of UEs, or a bandwidth of a CORESET #0 of the cell, or both.

In some embodiments, the processor 900 supports wideband operation and is configured to receive, in a respective PO, a first paging message. In such embodiments, the first paging message may be transmitted on a frequency resource that is outside of the common channel monitoring resource.

In some embodiments, the processor 900 is further configured to receive a first DCI message (e.g., including first-stage DCI) and determine a first PO. In such embodiments, the processor 900 is further configured to receive a second DCI message (e.g., including second-stage DCI) in the first PO, where a plurality of POs corresponds to different frequency resources during a same time period.

In certain embodiments, to determine the first PO, the processor 900 is configured to select the first PO based at least in part on an identifier of the processor 900 and a number of the plurality of POs corresponding to the same time period.

In various implementations, the processor 900 may support the functions of a base station, in accordance with examples as disclosed herein. For example, the processor 900 may be configured to support a means for determining a set of one or more supported bandwidths for a plurality of UEs (e.g., served by the base station), where each UE of the plurality of UEs corresponds to at least a first type of UE or a second type of UE. In some embodiments, the first type of UE comprises a WB-UE (e.g., supporting wideband operation) and the second type of UE comprising a BL-UE (e.g., having a limited bandwidth as compared to the WB-UE).

The processor 900 may be configured to support a means for configuring (e.g., designating) a common resource for channel monitoring (e.g., by the plurality of UEs) based at least in part on an initial bandwidth associated with initial access to the base station and the set of one or more supported bandwidths.

The processor 900 may be configured to support a means for transmitting a configuration message that indicates the common resource for channel monitoring, wherein the common resource is associated with a set of POs and a set of ROs. In some embodiments, to transmit the configuration message, the processor 900 is configured to broadcast the configuration message in a SI message. In certain embodiments, the configuration message may be a device-specific configuration message.

In some embodiments, the common resource for channel monitoring is configured based at least in part on a first initial BWP for the first type of UE and a second initial BWP for the second type of UE, where the first initial BWP encompasses the second initial BWP.

In certain embodiments, the set of POs comprises a first subset of POs associated with the first initial BWP and a second subset of POs associated with the second initial BWP. In such embodiments, the first subset of POs and the second subset of POs may be FDMed.

In certain embodiments, the set of ROs comprises a first subset of ROs associated with the first initial BWP and a second subset of ROs associated with the second initial BWP. In such embodiments, the first subset of ROs and the second subset of ROs may be FDMed.

In some embodiments, the common resource for channel monitoring is configured based at least in part on an initial BWP common for the first type of UE and the second type of UE, where the initial BWP corresponds to a maximum supported bandwidth associated with the second type of UE. In certain embodiments, the initial BWP is equal to a bandwidth associated with a SSB for a cell serving the plurality of UEs, or a bandwidth of a CORESET #0 of the cell, or both.

In certain embodiments, the initial BWP includes the set of POs comprising a first subset of POs, wherein the initial BWP excludes a second subset of POs of the set of POs. In such embodiments, the processor 900 is configured to allocate the first subset of POs for the second type of UE. In one embodiment, the processor 900 is further configured to allocate at least one or more of the first subset of POs for the second type of UE. In another embodiment, the processor 900 is further configured to allocate one or more POs of the first subset of POs for the first type of UE.

In certain embodiments, the initial BWP includes the set of ROs comprising a first subset of ROs, wherein the initial BWP excludes a second subset of ROs of the set of ROs. In such embodiments, the processor 900 is configured to allocate the first subset of ROs for the second type of UE. In one embodiment, the processor 900 is further configured to allocate at least one or more of the first set of ROs for the second type of UE. In another embodiment, the processor 900 is further configured to allocate at least one RO of the first subset of ROs for the first type of UE.

In some embodiments, the processor 900 may be configured to: A) transmit, in a respective PO, a first paging message to a first UE comprising the first type of UE; and B) transmit, in the respective PO, a second paging message to a second UE comprising the second type of UE. In such embodiments, the first paging message is transmitted on a frequency resource that is outside of a supported bandwidth of the second UE.

In some embodiments, the processor 900 is configured to: A) transmit, to at least one UE, a first DCI; B) determine a first PO for the at least one UE; and C) transmit, to the at least one UE, a second DCI during the first PO, wherein a plurality of POs correspond to different frequency resources during a same time period.

In certain embodiments, to determine the first PO, the processor 900 is configured to select the first PO based at least in part on an identifier of the at least one UE and a quantity of POs of the plurality of POs corresponding to the same time period.

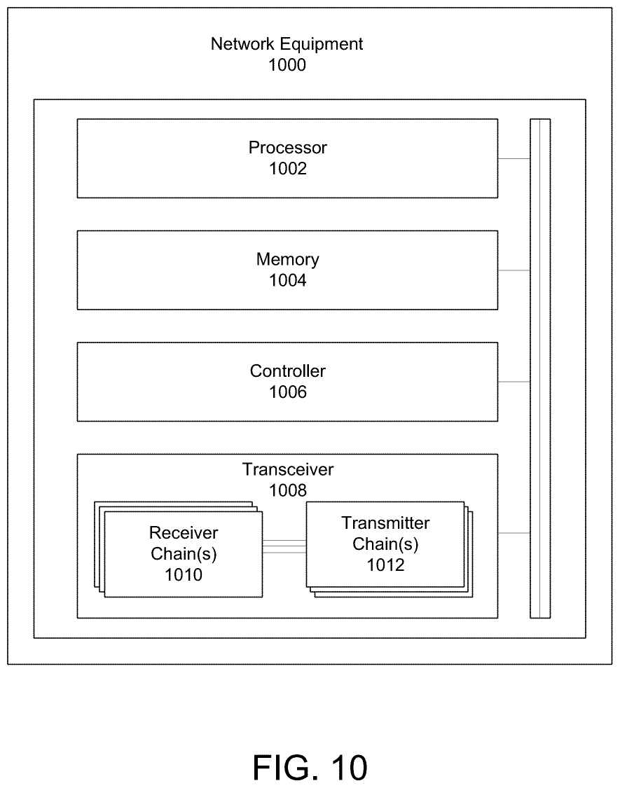

FIG. 10 illustrates an example of an NE 1000 in accordance with aspects of the present disclosure. The NE 1000 may include a processor 1002, a memory 1004, a controller 1006, and a transceiver 1008. The processor 1002, the memory 1004, the controller 1006, or the transceiver 1008, or various combinations thereof or various components thereof may be examples of means for performing various aspects of the present disclosure as described herein. These components may be coupled (e.g., operatively, communicatively, functionally, electronically, electrically) via one or more interfaces.

The processor 1002, the memory 1004, the controller 1006, or the transceiver 1008, or various combinations or components thereof may be implemented in hardware (e.g., circuitry). The hardware may include a processor, a DSP, an ASIC, or other programmable logic device, or any combination thereof configured as or otherwise supporting a means for performing the functions described in the present disclosure.

The processor 1002 may include an intelligent hardware device (e.g., a general-purpose processor, a DSP, a CPU, an ASIC, an FPGA, or any combination thereof). In some implementations, the processor 1002 may be configured to operate the memory 1004. In some other implementations, the memory 1004 may be integrated into the processor 1002. The processor 1002 may be configured to execute computer-readable instructions stored in the memory 1004 to cause the NE 1000 to perform various functions of the present disclosure.

The memory 1004 may include volatile or non-volatile memory. The memory 1004 may store computer-readable, computer-executable code including instructions when executed by the processor 1002 cause the NE 1000 to perform various functions described herein. The code may be stored in a non-transitory computer-readable medium such the memory 1004 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1002 and the memory 1004 coupled with the processor 1002 may be configured to cause the NE 1000 to perform one or more base station functions as described herein (e.g., executing, by the processor 1002, instructions stored in the memory 1004). Accordingly, the processor 1002 may support the communication at the NE 1000 in accordance with examples as disclosed herein.

For example, the NE 1000 may be configured to support a means for determining a set of one or more supported bandwidths for a plurality of UEs served by the NE 1000, where the plurality of UEs corresponds to at least two different device types. In some embodiments, the plurality of UEs includes at least a first type of UE supporting wideband operation and a second type of UE having a limited bandwidth.

The NE 1000 may be configured to support a means for configuring a common channel monitoring resource for the plurality of UEs based at least in part on an initial bandwidth for initial access to the NE 1000 and the set of one or more supported bandwidths.

The NE 1000 may be configured to support a means for transmitting a configuration message indicating the common channel monitoring resource, wherein the common channel monitoring resource is associated with a set of POs and a set of ROs. In some embodiments, to transmit the configuration message, the NE 1000 is configured to broadcast the configuration message in a SI message. In certain embodiments, the configuration message may be a device-specific configuration message.

In some embodiments, the common channel monitoring resource is configured based at least in part on a first initial BWP of the first type of UE and a second initial BWP of the second type of UE, where the first initial BWP encompasses the second initial BWP.

In certain embodiments, the set of POs comprises a first subset of POs within the first initial BWP and a second subset of POs within the second initial BWP. In such embodiments, the first subset of POs are FDMed with the second subset of POs.

In certain embodiments, the set of ROs comprises a first subset of ROs within the first initial BWP and a second subset of ROs within the second initial BWP. In such embodiments, the first subset of ROs are FDMed with the second subset of ROs.

In some embodiments, the common channel monitoring resource is configured based at least in part on an initial BWP common to the first type of UE and the second type of UE, where the initial BWP corresponds to a maximum supported bandwidth associated with the second type of UE. In certain embodiments, the initial BWP corresponds to a bandwidth of a SSB for a cell of the NE 1000, or a bandwidth of a CORESET #0 of the cell, or both.

In certain embodiments, the set of POs comprises a first subset of POs within the initial BWP and a second subset of POs outside the initial BWP. In such embodiments, the NE 1000 is configured to allocate the first subset of POs to the second type of UE. In one embodiment, the NE 1000 is further configured to allocate at least one or more of the first subset of POs only to the second type of UE. In another embodiment, the NE 1000 is further configured to allocate one or more POs of the first subset of POs to the first type of UE.

In certain embodiments, the set of ROs comprises a first subset of ROs within the initial BWP and a second subset of ROs outside the initial BWP. In such embodiments, the NE 1000 is configured to allocate the first subset of ROs to the second type of UE. In one embodiment, the NE 1000 is further configured to allocate at least one or more of the first subset of ROs only to the second type of UE. In another embodiment, the NE 1000 is further configured to allocate at least one RO of the first subset of ROs to the first type of UE.

In some embodiments, the NE 1000 may be configured to: A) transmit, in a respective PO of the set of POs, a first paging message for a first UE supporting wideband operation; and B) transmit, in the respective PO, a second paging message for a second UE having a limited bandwidth. In such embodiments, the first paging message is transmitted on a frequency resource that is outside of a supported bandwidth of the second UE.

In some embodiments, the NE 1000 is configured to: A) transmit, to at least one UE, a first DCI message; B) determine a first PO for the at least one UE; and C) transmit, to the at least one UE, a second DCI message in the first PO, wherein a plurality of POs correspond to different frequency resources during a same time period.

In certain embodiments, to determine the first PO, the NE 1000 is configured to select the first PO based at least in part on an identifier of the first UE and a quantity of the plurality of POs corresponding to the same time period.

The controller 1006 may manage input and output signals for the NE 1000. The controller 1006 may also manage peripherals not integrated into the NE 1000. In some implementations, the controller 1006 may utilize an operating system such as iOS®, ANDROID®, WINDOWS®, or other operating systems. In some implementations, the controller 1006 may be implemented as part of the processor 1002.

In some implementations, the NE 1000 may include at least one transceiver 1008. In some other implementations, the NE 1000 may have more than one transceiver 1008. The transceiver 1008 may represent a wireless transceiver. The transceiver 1008 may include one or more receiver chains 1010, one or more transmitter chains 1012, or a combination thereof.

A receiver chain 1010 may be configured to receive signals (e.g., control information, data, packets) over a wireless medium. For example, the receiver chain 1010 may include one or more antennas for receiving the signal over the air or wireless medium. The receiver chain 1010 may include at least one amplifier (e.g., a low-noise amplifier (LNA)) configured to amplify the received signal. The receiver chain 1010 may include at least one demodulator configured to demodulate the received signal and obtain the transmitted data by reversing the modulation technique applied during transmission of the signal. The receiver chain 1010 may include at least one decoder for decoding/processing the demodulated signal to receive the transmitted data.

A transmitter chain 1012 may be configured to generate and transmit signals (e.g., control information, data, packets). The transmitter chain 1012 may include at least one modulator for modulating data onto a carrier signal, preparing the signal for transmission over a wireless medium. The at least one modulator may be configured to support one or more techniques such as AM, FM, or digital modulation schemes like PSK or QAM. The transmitter chain 1012 may also include at least one power amplifier configured to amplify the modulated signal to an appropriate power level suitable for transmission over the wireless medium. The transmitter chain 1012 may also include one or more antennas for transmitting the amplified signal into the air or wireless medium.

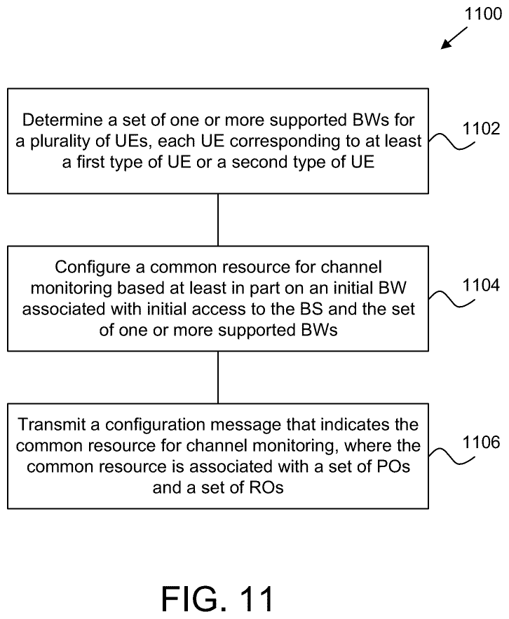

FIG. 11 depicts one embodiment of a method 1100 in accordance with aspects of the present disclosure. In various embodiments, the operations of the method 1100 may be implemented by a base station, as described herein. In some implementations, the base station may execute a set of instructions to control the function elements of the base station to perform the described functions.

At step 1102, the method 1100 may include determining a set of one or more supported bandwidths for a plurality of UEs, where each UE of the plurality of UEs corresponds to at least a first type of UE or a second type of UE. The operations of step 1102 may be performed in accordance with examples as described herein. In some implementations, aspects of the operations of step 1102 may be performed by an NE, as described with reference to FIG. 10.

At step 1104, the method 1100 may include configuring a monitoring resource for common channel based at least in part on an initial bandwidth associated with initial access to the base station and the set of one or more supported bandwidths. The operations of step 1104 may be performed in accordance with examples as described herein. In some implementations, aspects of the operations of step 1104 may be performed by an NE, as described with reference to FIG. 10.

At step 1106, the method 1100 may include transmitting a configuration message that indicates the common resource for channel monitoring, wherein the common resource for channel monitoring is associated with a set of POs and a set of ROs. The operations of step 1106 may be performed in accordance with examples as described herein. In some implementations, aspects of the operations of step 1106 may be performed by a NE, as described with reference to FIG. 10.

It should be noted that the method 1100 described herein describes one possible implementation, and that the operations and the steps may be rearranged or otherwise modified and that other implementations are possible.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A base station for wireless communication, comprising:
at least one memory; and
at least one processor coupled with the at least one memory and configured to cause the base station to:
determine a set of one or more supported bandwidths for a plurality of user equipments (UEs), wherein each UE of the plurality of UEs corresponds to at least a first type of UE or a second type of UE;
configure a common resource for channel monitoring based at least in part on an initial bandwidth associated with initial access to the base station and the set of one or more supported bandwidths; and
transmit a configuration message that indicates the common resource for channel monitoring, wherein the common resource is associated with a set of paging occasions (POs) and a set of random access channel (RACH) occasions (ROs).

2. The base station of claim 1, wherein the first type of UE comprises a wideband UE (WB-UE), and wherein the second type of UE comprises a bandwidth limited UE (BL-UE).

3. The base station of claim 2, wherein the common resource is configured based at least in part on a first initial bandwidth part (BWP) for the first type of UE and a second initial BWP for the second type of UE, and wherein the first initial BWP includes the second initial BWP.

4. The base station of claim 3, wherein the set of POs comprises a first subset of POs associated with the first initial BWP and a second subset of POs associated with the second initial BWP, and wherein the first subset of POs and the second subset of POs are frequency-division multiplexed.

5. The base station of claim 3, wherein the set of ROs comprises a first subset of ROs associated with the first initial BWP and a second subset of ROs associated with the second initial BWP, and wherein the first subset of ROs and the second subset of ROs are frequency-division multiplexed.

6. The base station of claim 2, wherein the common resource is configured based at least in part on an initial bandwidth part (BWP) common for the first type of UE and the second type of UE, and wherein the initial BWP corresponds to a maximum supported bandwidth associated with the second type of UE.

7. The base station of claim 6, wherein the initial BWP is equal to a bandwidth associated with a synchronization signal block (SSB) for a cell serving the plurality of UEs, or a bandwidth of a zeroth-index control resource set (CORESET #0) of the cell, or both.

8. The base station of claim 6, wherein the initial BWP includes the set of POs comprising a first subset of POs, wherein the initial BWP excludes a second subset of POs of the set of POs, and wherein the at least one processor is configured to cause the base station to allocate the first subset of POs for the second type of UE.

9. The base station of claim 8, wherein the at least one processor is further configured to cause the base station to allocate at least one or more of the first subset of POs for the second type of UE.

10. The base station of claim 8, wherein the at least one processor is further configured to cause the base station to allocate one or more POs of the first subset of POs for the first type of UE.

11. The base station of claim 6, wherein the initial BWP includes a first subset of ROs of the set of ROs, wherein the initial BWP excludes a second subset of ROs of the set of ROs, and wherein the at least one processor is configured to cause the base station to allocate the first subset of ROs for the second type of UE.

12. The base station of claim 11, wherein the at least one processor is further configured to cause the base station to allocate at least one or more ROs of the first subset of ROs for the second type of UE.

13. The base station of claim 11, wherein the at least one processor is further configured to cause the base station to allocate at least one RO of the first subset of ROs for the first type of UE.

14. The base station of claim 1, wherein the at least one processor is configured to cause the base station to:
transmit, in a respective PO, a first paging message to a first UE comprising the first type of UE; and
transmit, in the respective PO, a second paging message to a second UE comprising the second type of UE,
wherein the first paging message is transmitted on a frequency resource that is outside of a supported bandwidth of the second UE.

15. The base station of claim 1, wherein to transmit the configuration message, the at least one processor is configured to cause the base station to broadcast the configuration message in a system information (SI) message.

16. The base station of claim 1, wherein the at least one processor is configured to cause the base station to:
transmit, to at least one UE, a first downlink control information (DCI);
determine a first paging occasion (PO) for the at least one UE; and
transmit, to the at least one UE, a second DCI during the first PO, wherein a plurality of POs corresponds to different frequency resources during a same time period.

17. The base station of claim 16, wherein to determine the first PO, the at least one processor is configured to cause the base station to select the first PO based at least in part on an identifier of the at least one UE and a quantity of POs of the plurality of POs corresponding to the same time period.

18. A method performed by a base station, the method comprising:
determining a set of one or more supported bandwidths for a plurality of user equipments (UEs), wherein each UE of the plurality of UEs corresponds to at least a first type of UE or a second type of UE;
configuring a common resource for channel monitoring based at least in part on an initial bandwidth associated with initial access to the base station and the set of one or more supported bandwidths; and
transmitting a configuration message that indicated the common resource for channel monitoring, wherein the common resource is associated with a set of paging occasions (POs) and a set of random access channel (RACH) occasions (ROs).

19. The method of claim 18, further comprising:
transmitting, in a respective PO, a first paging message to a first UE comprising the first type of UE; and
transmitting, in the respective PO, a second paging message to a second UE comprising the second type of UE,
wherein the first paging message is transmitted on a frequency resource that is outside of a supported bandwidth of the second UE.

20. A processor for wireless communication, comprising:
at least one processor coupled with at least one memory and configured to cause the processor to:
determine a set of one or more supported bandwidths for a plurality of user equipments (UEs), wherein each UE of the plurality of UEs corresponds to at least a first type of UE or a second type of UE;
configure a common resource for channel monitoring based at least in part on an initial bandwidth associated with initial access to the base station and the set of one or more supported bandwidths; and
transmit a configuration message that indicates the common resource for channel monitoring, wherein the common resource is associated with a set of paging occasions (POs) and a set of random access channel (RACH) occasions (ROs).
